(19) United States
(12) Patent Application Publication
(10) Pub. No.: US 2026/0085140 A1
(43) Pub. Date: Mar. 26, 2026

(54) COMPOSITION AND POLYMER FORMED THEREFROM

(71) Applicants: Samsung Display Co., Ltd., Yongin-si (KR); Seoul National University R&DB Foundation, Seoul (KR)

(72) Inventors: Shinya Onoue, Yongin-si (KR); Minsang Kwon, Seoul (KR); Daehyun Hwang, Yongin-si (KR); Yonghwan Kwon, Seoul (KR); Seokju Lee, Seoul (KR); Hyeondeuk Hwang, Yongin-si (KR)

(21) Appl. No.: 19/333,079

(22) Filed: Sep. 18, 2025

(30) Foreign Application Priority Data
Sep. 24, 2024 (KR) 10-2024-0129426

(51) Int. Cl. C08F 222/20

(52) U.S. Cl. CPC C08F 222/20

(57) ABSTRACT

Provided is a composition including a visible light initiator mixture and a monomer. The visible light initiator mixture includes an ionic compound and a multi-aromatic ring-containing compound, and the monomer is a monomer in which a glass transition temperature (Tg) of a homopolymer of the monomer is 80° C. or more.

### CROSS-REFERENCE TO RELATED APPLICATION

The present application claims priority to and the benefit of Korean Patent Application No. 10-2024-0129426, filed on Sep. 24, 2024, in the Korean Intellectual Property Office, the entire content of which is hereby incorporated by reference.

### BACKGROUND

### 1. Field

One or more embodiments of the present disclosure relate to a composition and a polymer formed therefrom.

### 2. Description of the Related Art

Polymers prepared through thermosetting have problems in that the manufacturing time is relatively long, processes including molding are complex, and investment costs are increased due to the complex processes.

Although polymers prepared through photocuring have a benefit in terms of taking a relatively short time, there is a limitation in wavelength range and/or the like of light used for photocuring.

### SUMMARY

One or more embodiments of the present disclosure include a composition which exhibits excellent physical properties by being cured with visible light, and a polymer formed therefrom.

Additional aspects of embodiments will be set forth in part in the description which follows and, in part, will be apparent from the description, or may be learned by practice of the presented embodiments of the disclosure.

According to one or more embodiments, a composition includes a visible light initiator mixture, and a monomer, wherein the visible light initiator mixture includes an ionic compound and a multi-aromatic ring-containing compound, and the monomer is a monomer in which a glass transition temperature (Tg) of a homopolymer of the monomer is 80° C. or more.

According to one or more embodiments, a polymer is formed by irradiating visible light onto the composition.

### DETAILED DESCRIPTION

Reference will now be made in more detail to embodiments, wherein like reference numerals refer to like elements throughout. In this regard, the present embodiments may have different forms and should not be construed as being limited to the descriptions set forth herein. Accordingly, the embodiments are merely described below to explain aspects of embodiments of the present description. As used herein, the term “and/or” includes any and all combinations of one or more of the associated listed items. Throughout the disclosure, the expression “at least one of a, b or c” indicates only a, only b, only c, both a and b, both a and c, both b and c, all of a, b, and c, or variations thereof.

Although polymers prepared through photocuring have a benefit in terms of taking a relatively short time, there is a limitation on a wavelength range and/or the like of light used for photocuring.

For example, in the case of a composition that is cured by ultraviolet (UV) rays, photocuring is difficult when a layer that blocks UV rays is present on the composition.

Even for a composition that is curable with visible light, an initiator present in the composition may not be suitably or appropriately dispersed, and the physical properties of the polymer generated after curing may not be excellent.

After a long study, the present inventors have prepared a composition which is a composition curable with visible light and in which an initiator is suitably or appropriately dispersed so that a polymer generated after curing also has excellent physical properties.

A composition according to an aspect may be a composition including a visible light initiator mixture, and a monomer.

In embodiments, the visible light initiator mixture may include an ionic compound and a multi-aromatic ring-containing compound.

The monomer may be a monomer in which a glass transition temperature (Tg) of a homopolymer of the monomer is 80° C. or more.

The visible light initiator mixture including the ionic compound and the multi-aromatic ring-containing compound may form radicals in visible light, which is suitable or necessary for a monomer to become a polymer.

In other systems, there may be a problem in that the visible light initiator mixture is not suitably or appropriately dispersed in a monomer. As a result, an initiation reaction may also proceed inefficiently, and physical properties may be likely to become non-uniform.

After a long study, the present inventors have discovered that, by dispersing/dissolving a visible light initiator mixture in a monomer which is an acrylamide-based monomer and of which a homopolymer has a Tg of 80° C. or more, solubility with respect to the entire resin may be considerably improved to impart an efficient curing behavior, and an elastic modulus of a final cured product may become a suitably or sufficiently high elastic modulus to improve impact resistance and/or the like.

The term “Tg of a homopolymer” generally refers to the characteristics of a monomer and is described in the description of a monomer in a catalog of a company selling the monomer.

For example, in the case of a monomer such as (meth)acrylic group (CH₂═C(H, Me)-C(═O)—O—R′) or (meth)acrylamide group (CH₂═C(H, Me)-C(═O)—N(H, R′₁)—R′₂), Tg changes significantly depending on a chemical structure of R′, R′₁, or R′₂. “Tg of the homopolymer” is an important guideline value for determining how much Tg changes depending on R′, R′₁, or R′₂.

According to an embodiment, the visible light initiator mixture may generate radicals upon exposure to light with a wavelength of about 400 nm to about 560 nm.

The multi-aromatic ring-containing compound in the visible light initiator mixture refers to a compound including a plurality of aromatic rings. For example, the multi-aromatic ring-containing compound may include a compound including nine or more phenyl moieties.

According to an embodiment, the multi-aromatic ring-containing compound may include a first compound represented by Formula 1 below:

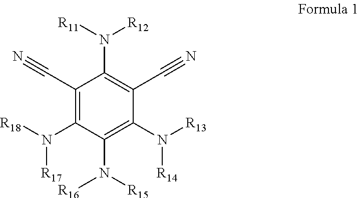

R₁₁ to R₁₈ may each independently be hydrogen, deuterium, —F, —Cl, —Br, —I, a hydroxyl group, a cyano group, a nitro group, a C₁-C₆₀ alkyl group unsubstituted or substituted with at least one R₁₀ₐ, a C₂-C₆₀ alkenyl group unsubstituted or substituted with at least one R₁₀ₐ, a C₂-C₆₀ alkynyl group unsubstituted or substituted with at least one R₁₀ₐ, a C₁-C₆₀ alkoxy group unsubstituted or substituted with at least one R₁₀ₐ, a C₃-C₆₀ carbocyclic group unsubstituted or substituted with at least one R₁₀ₐ, a C₁-C₆₀ heterocyclic group unsubstituted or substituted with at least one R₁₀ₐ, a C₆-C₆₀ aryloxy group unsubstituted or substituted with at least one R₁₀ₐ, a C₆-C₆₀ arylthio group unsubstituted or substituted with at least one R₁₀ₐ, —Si(Q₁)(Q₂)(Q₃), —N(Q₁)(Q₂), —B(Q₁)(Q₂), —C(═O)(Q₁), —S(═O)₂(Q₁), or —P(═O)(Q₁)(Q₂),
two or more adjacent ones of R₁₁ to R₁₈ may be optionally linked to each other to form a C₅-C₃₀ carbocyclic group unsubstituted or substituted with at least one R₁₀ₐ or a C₁-C₃₀ heterocyclic group unsubstituted or substituted with at least one R₁₀ₐ,
R₁₀ₐ may be: deuterium, —F, —Cl, —Br, —I, a hydroxyl group, a cyano group, or a nitro group; a C₁-C₆₀ alkyl group, a C₂-C₆₀ alkenyl group, a C₂-C₆₀ alkynyl group, or a C₁-C₆₀ alkoxy group, each unsubstituted or substituted with deuterium, —F, —Cl, —Br, —I, a hydroxyl group, a cyano group, a nitro group, a C₅-C₆₀ carbocyclic group, a C₁-C₆₀ heterocyclic group, a C₆-C₆₀ aryloxy group, a C₆-C₆₀ arylthio group, a C₇-C₆₀ arylalkyl group, a C₂-C₆₀ heteroarylalkyl group, —Si(Q₁₁)(Q₁₂)(Q₁₃), —N(Q₁₁)(Q₁₂), —B(Q₁₁)(Q₁₂), —C(═O)(Q₁₁), —S(═O)₂(Q₁₁), —P(═O)(Q₁₁)(Q₁₂), or any combination thereof; a C₃-C₆₀ carbocyclic group, a C₁-C₆₀ heterocyclic group, a C₆-C₆₀ aryloxy group, a C₆-C₆₀ arylthio group, a C₇-C₆₀ arylalkyl group, or a C₂-C₆₀ heteroarylalkyl group, each unsubstituted or substituted with deuterium, —F, —Cl, —Br, —I, a hydroxyl group, a cyano group, a nitro group, a C₁-C₆₀ alkyl group, a C₂-C₆₀ alkenyl group, a C₂-C₆₀ alkynyl group, a C₁-C₆₀ alkoxy group, a C₅-C₆₀ carbocyclic group, a C₁-C₆₀ heterocyclic group, a C₆-C₆₀ aryloxy group, a C₆-C₆₀ arylthio group, a C₇-C₆₀ arylalkyl group, a C₂-C₆₀ heteroarylalkyl group, Si(Q₂₁)(Q₂₂)(Q₂₃), —N(Q₂₁)(Q₂₂), —B(Q₂₁)(Q₂₂), —C(═O)(Q₂₁), —S(═O)₂(Q₂₁), —P(═O)(Q₂₁)(Q₂₂), or any combination thereof; or —Si(Q₃₁)(Q₃₂)(Q₃₃), —N(Q₃₁)(Q₃₂), —B(Q₃₁)(Q₃₂), —C(═O)(Q₃₁), —S(═O)₂(Q₃₁), or —P(═O)(Q₃₁)(Q₃₂), and
Q₁ to Q₃, Q₁₁ to Q₁₃, Q₂₁ to Q₂₃, and Q₃₁ to Q₃₃ may each independently be: hydrogen; deuterium; —F; —Cl; —Br; —I; a hydroxyl group; a cyano group; a nitro group; a C₁-C₆₀ alkyl group; a C₂-C₆₀ alkenyl group; a C₂-C₆₀ alkynyl group; a C₁-C₆₀ alkoxy group; or

a C₃-C₆₀ carbocyclic group, a C₁-C₆₀ heterocyclic group, a C₇-C₆₀ arylalkyl group, or a C₂-C₆₀ heteroarylalkyl group, each unsubstituted or substituted with deuterium, —F, a cyano group, a C₁-C₆₀ alkyl group, a C₁-C₆₀ alkoxy group, a phenyl group, a biphenyl group, or any combination thereof.

According to an embodiment, the first compound may be represented by Formula 1-1 or Formula 1-2 below.

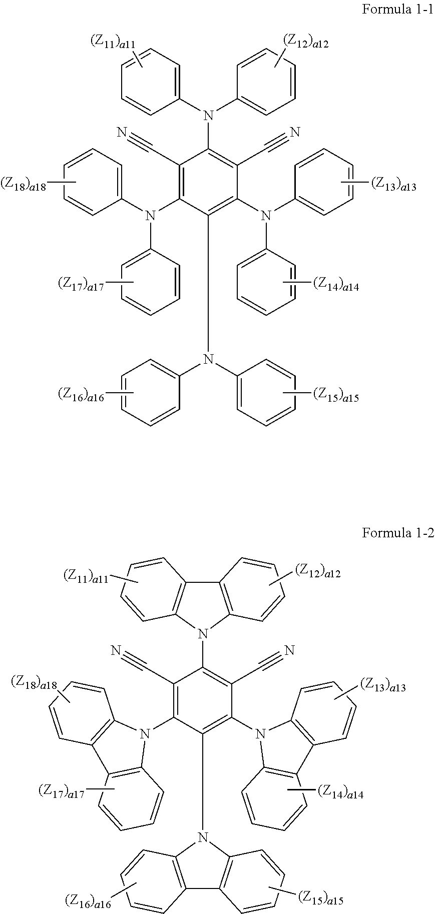

In Formulae 1-1 and 1-2,
Z₁₁ to Z₁₈ may each independently be hydrogen or defined the same as R₁₀ₐ, and
a11 to a18 may each independently be an integer from 1 to 4 or 1 to 5.

According to an embodiment, the first compound may include at least one selected from compounds below:

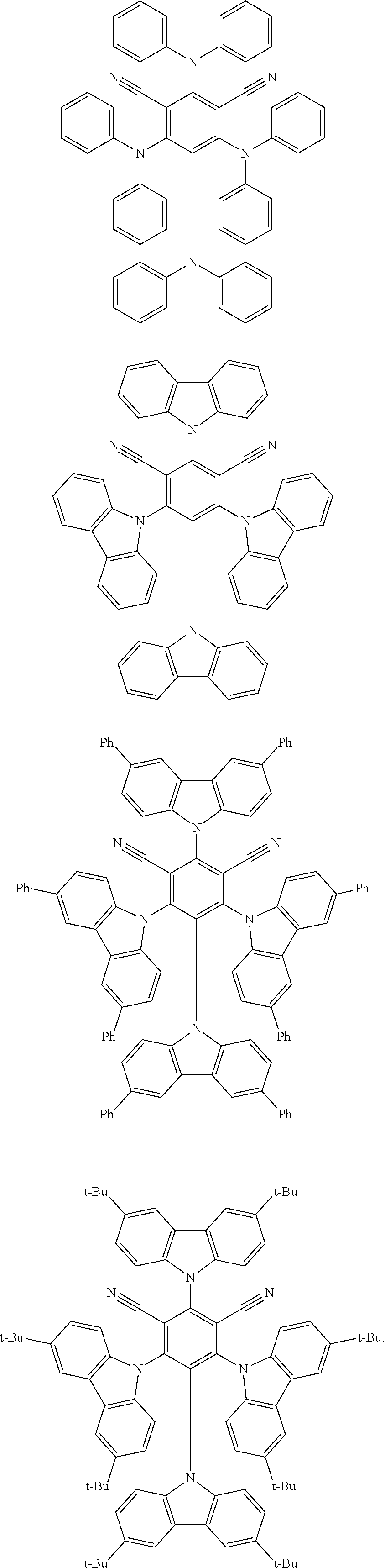

According to an embodiment, the ionic compound may include a second compound represented by Formula 2 below, a third compound represented by Formula 3 below, or any combination thereof:

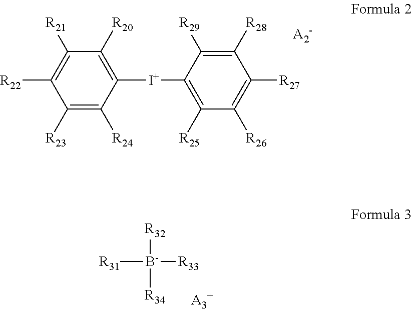

wherein, in Formulae 2 and 3,
A₂_{^{−}} may be a counter anion,
A₃_{⁺} may be a counter cation,
R₂₀ to R₂₉ and R₃₁ to R₃₄ may each independently be hydrogen, deuterium, —F, —Cl, —Br, —I, a hydroxyl group, a cyano group, a nitro group, a C₁-C₆₀ alkyl group unsubstituted or substituted with at least one R₁₀ₐ, a C₂-C₆₀ alkenyl group unsubstituted or substituted with at least one R₁₀ₐ, a C₂-C₆₀ alkynyl group unsubstituted or substituted with at least one R₁₀ₐ, a C₁-C₆₀ alkoxy group unsubstituted or substituted with at least one R₁₀ₐ, a C₃-C₆₀ carbocyclic group unsubstituted or substituted with at least one R₁₀ₐ, a C₁-C₆₀ heterocyclic group unsubstituted or substituted with at least one R₁₀ₐ, a C₆-C₆₀ aryloxy group unsubstituted or substituted with at least one R₁₀ₐ, a C₆-C₆₀ arylthio group unsubstituted or substituted with at least one R₁₀ₐ, —Si(Q₁)(Q₂)(Q₃), —N(Q₁)(Q₂), —B(Q₁)(Q₂), —C(═O)(Q₁), —S(═O)₂(Q₁), or —P(═O)(Q₁)(Q₂),
two or more adjacent ones of R₂₀ to R₂₉ may be optionally linked to each other to form a C₅-C₃₀ carbocyclic group unsubstituted or substituted with at least one R₁₀ₐ or a C₁-C₃₀ heterocyclic group unsubstituted or substituted with at least one R₁₀ₐ,
two or more adjacent ones of R₃₁ to R₃₄ may be optionally linked to each other to form a C₅-C₃₀ carbocyclic group unsubstituted or substituted with at least one R₁₀ₐ or a C₁-C₃₀ heterocyclic group unsubstituted or substituted with at least one R₁₀ₐ,
R₁₀ₐ may be: deuterium, —F, —Cl, —Br, —I, a hydroxyl group, a cyano group, or a nitro group; a C₁-C₆₀ alkyl group, a C₂-C₆₀ alkenyl group, a C₂-C₆₀ alkynyl group, or a C₁-C₆₀ alkoxy group, each unsubstituted or substituted with deuterium, —F, —Cl, —Br, —I, a hydroxyl group, a cyano group, a nitro group, a C₃-C₆₀ carbocyclic group, a C₁-C₆₀ heterocyclic group, a C₆-C₆₀ aryloxy group, a C₆-C₆₀ arylthio group, a C₇-C₆₀ arylalkyl group, a C₂-C₆₀ heteroarylalkyl group, —Si(Q₁₁)(Q₁₂)(Q₁₃), —N(Q₁₁)(Q₁₂), —B(Q₁₁)(Q₁₂), —C(═O)(Q₁₁), —S(═O)₂(Q₁₁), —P(═O)(Q₁₁)(Q₁₂), or any combination thereof; a C₃-C₆₀ carbocyclic group, a C₁-C₆₀ heterocyclic group, a C₆-C₆₀ aryloxy group, a C₆-C₆₀ arylthio group, a C₇-C₆₀ arylalkyl group, or a C₂-C₆₀ heteroarylalkyl group, each unsubstituted or substituted with deuterium, —F, —Cl, —Br, —I, a hydroxyl group, a cyano group, a nitro group, a C₁-C₆₀ alkyl group, a C₂-C₆₀ alkenyl group, a C₂-C₆₀ alkynyl group, a C₁-C₆₀ alkoxy group, a C₅-C₆₀ carbocyclic group, a C₁-C₆₀ heterocyclic group, a C₆-C₆₀ aryloxy group, a C₆-C₆₀ arylthio group, a C₇-C₆₀ arylalkyl group, a C₂-C₆₀ heteroarylalkyl group, Si(Q₂₁)(Q₂₂)(Q₂₃), —N(Q₂₁)(Q₂₂), —B(Q₂₁)(Q₂₂), —C(═O)(Q₂₁), —S(═O)₂(Q₂₁), —P(═O)(Q₂₁)(Q₂₂), or any combination thereof; or —Si(Q₃₁)(Q₃₂)(Q₃₃), —N(Q₃₁)(Q₃₂), —B(Q₃₁)(Q₃₂), —C(═O)(Q₃₁), —S(═O)₂(Q₃₁), or —P(═O)(Q₃₁)(Q₃₂), and
Q₁ to Q₃, Q₁₁ to Q₁₃, Q₂₁ to Q₂₃, and Q₃₁ to Q₃₃ may each independently be: hydrogen; deuterium; —F; —Cl; —Br; —I; a hydroxyl group; a cyano group; a nitro group; a C₁-C₆₀ alkyl group; a C₂-C₆₀ alkenyl group; a C₂-C₆₀ alkynyl group; a C₁-C₆₀ alkoxy group; or
a C₃-C₆₀ carbocyclic group, a C₁-C₆₀ heterocyclic group, a C₇-C₆₀ arylalkyl group, or a C₂-C₆₀ heteroarylalkyl group, each unsubstituted or substituted with deuterium, —F, a cyano group, a C₁-C₆₀ alkyl group, a C₁-C₆₀ alkoxy group, a phenyl group, a biphenyl group, or any combination thereof.

According to an embodiment, A₂_{^{−}} may include a fluorine atom.

According to an embodiment, A₃_{⁺} may be [P(R₃₁ₐ)(R_{31b})(R_{31c}) (R_{31d})]⁺ or [N(R₃₂ₐ) (R_{32b}) (R_{32c}) (R_{32d})]⁺.

R₃₁ₐ, R_{31b}, R_{31c}, R_{31d}, R₃₂ₐ, R_{32b}, R_{32c}, and R_{32d} may each independently be a C₁-C₆₀ alkyl group unsubstituted or substituted with at least one R₁₀ₐ, a C₂-C₆₀ alkenyl group unsubstituted or substituted with at least one R₁₀ₐ, a C₂-C₆₀ alkynyl group unsubstituted or substituted with at least one R₁₀ₐ, a C₁-C₆₀ alkoxy group unsubstituted or substituted with at least one R₁₀ₐ, a C₃-C₆₀ carbocyclic group unsubstituted or substituted with at least one R₁₀ₐ, or a C₁-C₆₀ heterocyclic group unsubstituted or substituted with at least one R₁₀ₐ.

R₁₀ₐ may be as defined above.

According to an embodiment, the second compound may include at least one selected from compounds below:

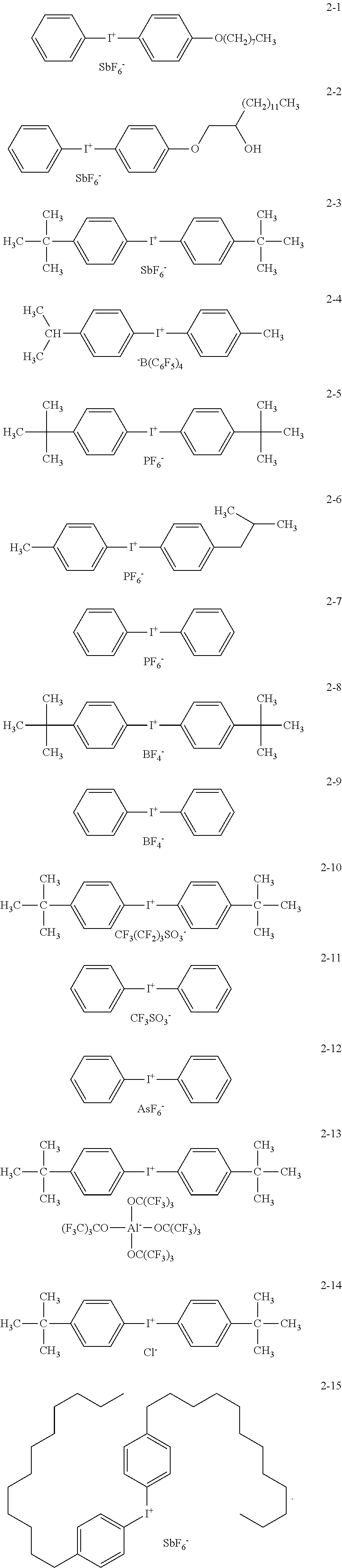

According to an embodiment, the third compound may include at least one selected from compounds below:

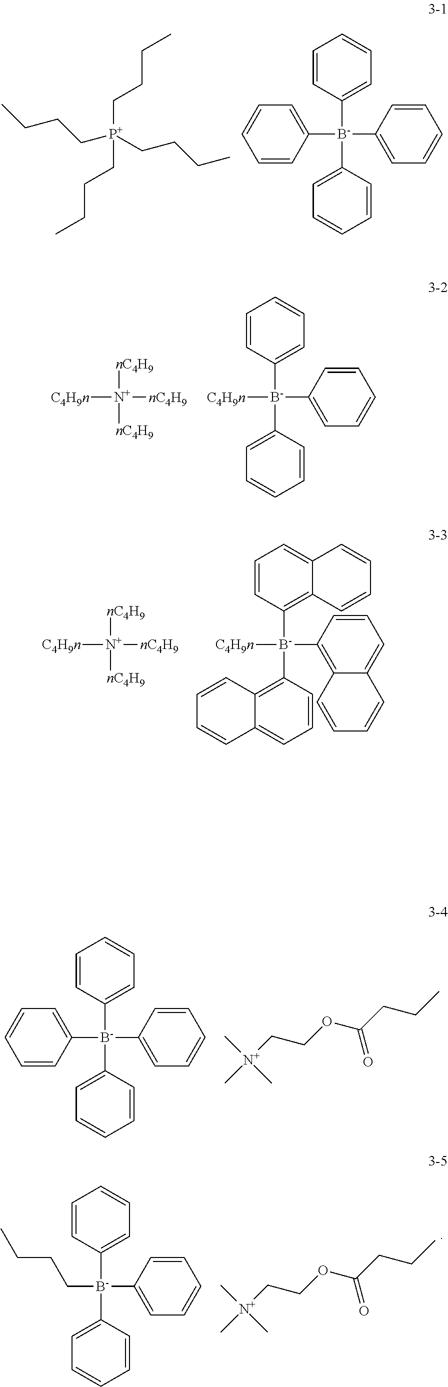

According to an embodiment, the monomer may include a (meth)acrylamide-based monomer. For example, the monomer may include an acrylamide-based monomer and/or a methacrylamide-based monomer.

According to an embodiment, the monomer may include a fourth compound represented by Formula 4 below:

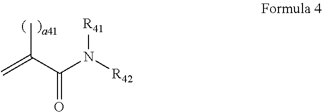

In Formula 4, R₄₁ and R₄₂ may each independently be a C₁-C₆₀ alkyl group unsubstituted or substituted with at least one R₁₀ₐ, a C₂-C₆₀ alkenyl group unsubstituted or substituted with at least one R₁₀ₐ, a C₂-C₆₀ alkynyl group unsubstituted or substituted with at least one R₁₀ₐ, a C₁-C₆₀ alkoxy group unsubstituted or substituted with at least one R₁₀ₐ, a C₃-C₆₀ carbocyclic group unsubstituted or substituted with at least one R₁₀ₐ, or a C₁-C₆₀ heterocyclic group unsubstituted or substituted with at least one R₁₀ₐ,
a41 may be 0 or 1,
R₄₁ and R₄₂ may be optionally linked to each other to form a C₅-C₃₀ carbocyclic group unsubstituted or substituted with at least one R₁₀ₐ or a C₁-C₃₀ heterocyclic group unsubstituted or substituted with at least one R₁₀ₐ,

R₁₀ₐ may be: deuterium, —F, —Cl, —Br, —I, a hydroxyl group, a cyano group, or a nitro group; a C₁-C₆₀ alkyl group, a C₂-C₆₀ alkenyl group, a C₂-C₆₀ alkynyl group, or a C₁-C₆₀ alkoxy group, each unsubstituted or substituted with deuterium, —F, —Cl, —Br, —I, a hydroxyl group, a cyano group, a nitro group, a C₅-C₆₀ carbocyclic group, a C₁-C₆₀ heterocyclic group, a C₆-C₆₀ aryloxy group, a C₆-C₆₀ arylthio group, a C₇-C₆₀ arylalkyl group, a C₂-C₆₀ heteroarylalkyl group, —Si(Q₁₁)(Q₁₂)(Q₁₃), —N(Q₁₁)(Q₁₂), —B(Q₁₁)(Q₁₂), —C(═O)(Q₁₁), —S(═O)₂(Q₁₁), —P(═O)(Q₁₁)(Q₁₂), or any combination thereof; a C₃-C₆₀ carbocyclic group, a C₁-C₆₀ heterocyclic group, a C₆-C₆₀ aryloxy group, a C₆-C₆₀ arylthio group, a C₇-C₆₀ arylalkyl group, or a C₂-C₆₀ heteroarylalkyl group, each unsubstituted or substituted with deuterium, —F, —Cl, —Br, —I, a hydroxyl group, a cyano group, a nitro group, a C₁-C₆₀ alkyl group, a C₂-C₆₀ alkenyl group, a C₂-C₆₀ alkynyl group, a C₁-C₆₀ alkoxy group, a C₅-C₆₀ carbocyclic group, a C₁-C₆₀ heterocyclic group, a C₆-C₆₀ aryloxy group, a C₆-C₆₀ arylthio group, a C₇-C₆₀ arylalkyl group, a C₂-C₆₀ heteroarylalkyl group, Si(Q₂₁)(Q₂₂)(Q₂₃), —N(Q₂₁)(Q₂₂), —B(Q₂₁)(Q₂₂), —C(═O)(Q₂₁), —S(═O)₂(Q₂₁), —P(═O)(Q₂₁)(Q₂₂), or any combination thereof; or —Si(Q₃₁)(Q₃₂)(Q₃₃), —N(Q₃₁)(Q₃₂), —B(Q₃₁)(Q₃₂), —C(═O)(Q₃₁), —S(═O)₂(Q₃₁), or —P(═O)(Q₃₁)(Q₃₂), and
Q₁ to Q₃, Q₁₁ to Q₁₃, Q₂₁ to Q₂₃, and Q₃₁ to Q₃₃ may each independently be: hydrogen; deuterium; —F; —Cl; —Br; —I; a hydroxyl group; a cyano group; a nitro group; a C₁-C₆₀ alkyl group; a C₂-C₆₀ alkenyl group; a C₂-C₆₀ alkynyl group; a C₁-C₆₀ alkoxy group; or
a C₃-C₆₀ carbocyclic group, a C₁-C₆₀ heterocyclic group, a C₇-C₆₀ arylalkyl group, or a C₂-C₆₀ heteroarylalkyl group, each unsubstituted or substituted with deuterium, —F, a cyano group, a C₁-C₆₀ alkyl group, a C₁-C₆₀ alkoxy group, a phenyl group, a biphenyl group, or any combination thereof.

According to an embodiment, the fourth compound may include at least one selected from compounds below:

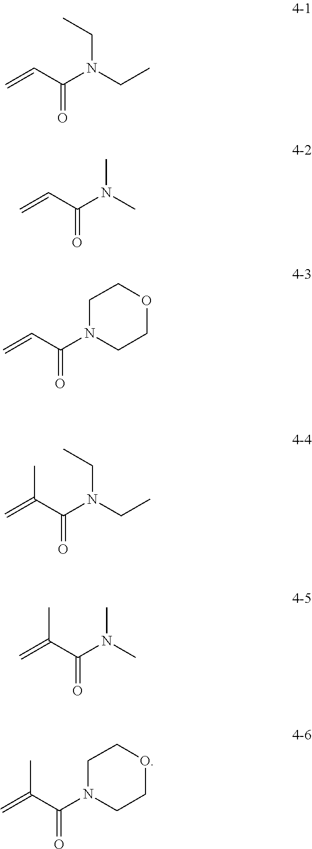

According to an embodiment, a concentration of the multi-aromatic ring-containing compound may be greater than 0 ppm and less than or equal to 100 ppm. For example, the concentration of the multi-aromatic ring-containing compound may be in a range of about 1 ppm to about 80 ppm. When the concentration of the multi-aromatic ring-containing compound is within the above ranges, the multi-aromatic ring-containing compound may act catalytically, may not have absorbency, and the composition may be deeply cured.

According to an embodiment, a concentration of the second compound may be in a range of about 500 ppm to about 2,000 ppm.

According to an embodiment, a concentration of the third compound may be in a range of about 600 ppm to about 2,000 ppm.

For example, the concentration of the second compound may be in a range of about 600 ppm to about 1,900 ppm, and the concentration of the third compound may be in a range of about 700 ppm to about 1,900 ppm.

When the concentration of the second compound and the concentration of the third compound are within the above ranges, radicals useful or required for curing the composition according to an embodiment may be continuously generated in accordance with the concentration of the multi-aromatic ring-containing compound.

According to an embodiment, a content of the monomer may be in a range of about 1 wt % to about 50 wt %. For example, the content of the monomer may be in a range of about 5 wt % to about 30 wt %. When the content of the monomer content deviates from the above ranges, the physical properties of a produced polymer may not be good.

In the composition according to an embodiment, excluding the content (e.g., amount) of the monomer, the content (e.g., amount) of the multi-aromatic ring-containing compound, the content (e.g., amount) of the second compound, and the content (e.g., amount) of the third compound, the remainder may include other monomers (with respect to 100 wt % of the entire composition).

For example, the other monomers may include an acrylic monomer. A content (e.g., amount) of the other monomers may be, for example, in a range of about 30 wt % to about 60 wt % (with respect to 100 wt % of the entire composition).

According to an embodiment, the other monomers may include an acrylic monomer and/or a diisocyanate-based monomer.

According to an embodiment, the acrylic monomer may include a C₁-C₂₀ alkyl group, a C₃-C₁₀ cycloalkyl group, —NCO, —OH, or any combination thereof.

According to an embodiment, the other monomers may include isobornyl acrylate (IBOA), an acrylic acid, methyl acrylate, ethyl acrylate, isopropyl acrylate, n-butyl (meth)acrylate, isobutyl acrylate, tert-butyl acrylate, n-pentyl acrylate, n-hexyl acrylate, cyclohexyl acrylate, n-heptyl acrylate, n-octyl acrylate, 2-ethylhexyl acrylate (EHA), nonyl acrylate, decyl acrylate, 2-isocyanatoethyl acrylate, 2,4-toluene diisocyanate, isophorone diisocyanate, hexamethylene diisocyanate, methylene diphenyl diisocyanate, 2-hydroxyethyl methacrylate, glycol methacrylate, glycol monomethacrylate, ethylene glycol methacrylate, 2-(methacryloyloxy) ethanol, or any combination thereof.

In the composition according to an embodiment, excluding the content (e.g., amount) of the monomer, the content (e.g., amount) of the multi-aromatic ring-containing compound, the content (e.g., amount) of the second compound, and the content (e.g., amount) of the third compound, the remainder may include other monomers and a solvent (with respect to 100 wt % of the entire composition). The solvent may include, for example, n-hexane, toluene, xylene, acetone, ethanol, isopropyl alcohol, or any combination thereof.

According to another aspect of embodiments, there may be provided a polymer formed by irradiating visible light onto the composition.

For example, the polymer according to an embodiment may be formed by curing the composition for about 0.1 second to about 5 minutes with visible light. For example, the polymer according to an embodiment may be formed by curing the composition for about 10 seconds to about 3 minutes with visible light.

According to an embodiment, a peak a wavelength of the irradiating visible light may be in a range of about 400 nm to about 560 nm. For example, the peak the wavelength of the visible light may be in a range of about 430 nm to about 490 nm. For example, the peak the wavelength of the visible light may be in a range of about 450 nm to about 480 nm.

According to an embodiment, a modulus of the polymer may be 200 MPa or more.

According to an embodiment, elongation of the polymer may be in a range of about 5% to about 100%.

According to an embodiment, breaking strength of the polymer may be 20 MPa or more.

For example, the modulus of the polymer may be 500 MPa or more, the elongation of the polymer may be 50% or more, and the breaking strength of the polymer may be 30 MPa or more.

The composition according to an embodiment may be unsuitable for use as an adhesive material such as a pressure-sensitive adhesive or an optically transparent adhesive or as a flexible film.

### Definition of Terms

As used herein, the term “C₃-C₆ carbocyclic group” refers to a cyclic group having 3 to 60 carbon atoms and consisting only of carbon as a ring-forming atom, and the term “C₁-C₆₀ heterocyclic group” refers to a cyclic group having 1 to 60 carbon atoms and further including a heteroatom as a ring-forming atom in addition to carbon. Each of the C₃-C₆₀ carbocyclic group and the C₁-C₆₀ heterocyclic group may be a monocyclic group having one ring or a polycyclic group in which two or more rings are condensed with each other. For example, the number of ring-forming atoms of the C₁-C₆₀ heterocyclic group may be in a range of 3 to 61.

As used herein, the term “cyclic group” includes both the C₃-C₆₀ carbocyclic group and the C₁-C₆₀ heterocyclic group.

As used herein, the term “π electron-rich C₃-C₆₀ cyclic group” refers to a cyclic group that has 3 to 60 carbon atoms and does not include *—N═*′ as a ring-forming moiety, and the term “π electron-deficient nitrogen-containing C₁-C₆₀ cyclic group” refers to a heterocyclic group that has 1 to 60 carbon atoms and includes *—N═*′ as a ring-forming moiety.

For example, the C₃-C₆₀ carbocyclic group may be i) a group T1 or ii) a condensed ring group in which two or more groups T1 are condensed with each other (for example, a cyclopentadiene group, an adamantane group, a norbornane group, a benzene group, a pentalene group, a naphthalene group, an azulene group, an indacene group, an acenaphthylene group, a phenalene group, a phenanthrene group, an anthracene group, a fluoranthene group, a triphenylene group, a pyrene group, a chrysene group, a perylene group, a pentaphene group, a heptalene group, a naphthacene group, a picene group, a hexacene group, a pentacene group, a rubicene group, a coronene group, an ovalene group, an indene group, a fluorene group, a spiro-bifluorene group, a benzofluorene group, an indenophenanthrene group, or an indenoanthracene group).

The C₁-C₆₀ heterocyclic group may be i) a group T2, ii) a fused ring group in which two or more groups T2 are fused with each other, or iii) a fused ring group in which one or more groups T2 and one or more groups T1 are fused with each other (for example, a pyrrole group, a thiophene group, a furan group, an indole group, a benzoindole group, a naphthoindole group, an isoindole group, a benzoisoindole group, a naphthoisoindole group, a benzosilole group, a benzothiophene group, a benzofuran group, a carbazole group, a dibenzosilole group, a dibenzothiophene group, a dibenzofuran group, an indenocarbazole group, an indolocarbazole group, a benzofurocarbazole group, a benzothienocarbazole group, a benzosilolocarbazole group, a benzoindolocarbazole group, a benzocarbazole group, a benzonaphthofuran group, a benzonaphthothiophene group, a benzonaphthosilole group, a benzofurodibenzofuran group, a benzofurodibenzothiophene group, a benzothienodibenzothiophene group, a pyrazole group, an imidazole group, a triazole group, an oxazole group, an isoxazole group, an oxadiazole group, a thiazole group, an isothiazole group, a thiadiazole group, a benzopyrazole group, a benzimidazole group, a benzoxazole group, a benzoisoxazole group, a benzothiazole group, a benzoisothiazole group, a pyridine group, a pyrimidine group, a pyrazine group, a pyridazine group, a triazine group, a quinoline group, an isoquinoline group, a benzoquinoline group, a benzoisoquinoline group, a quinoxaline group, a benzoquinoxaline group, a quinazoline group, a benzoquinazoline group, a phenanthroline group, a cinnoline group, a phthalazine group, a naphthyridine group, an imidazopyridine group, an imidazopyrimidine group, an imidazotriazine group, an imidazopyrazine group, an imidazopyridazine group, an azacarbazole group, an azafluorene group, an azadibenzosilole group, an azadibenzothiophene group, or an azadibenzofuran group).

The π electron-rich C₃-C₆₀ cyclic group may be i) a group T1, ii) a fused ring group in which two or more groups T1 are fused with each other, iii) a group T3, iv) a fused ring group in which two or more groups T3 are fused with each other, or v) a fused ring group in which one or more groups T3 and one or more groups T1 are fused with each other (for example, the C₃-C₆₀ carbocyclic group, a 1H-pyrrole group, a silole group, a borole group, a 2H-pyrrole group, a 3H-pyrrole group, a thiophene group, a furan group, an indole group, a benzoindole group, a naphthoindole group, an isoindole group, a benzoisoindole group, a naphthoisoindole group, a benzosilole group, a benzothiophene group, a benzofuran group, a carbazole group, a dibenzosilole group, a dibenzothiophene group, a dibenzofuran group, an indenocarbazole group, an indolocarbazole group, a benzofurocarbazole group, a benzothienocarbazole group, a benzosilolocarbazole group, a benzoindolocarbazole group, a benzocarbazole group, a benzonaphthofuran group, a benzonaphthothiophene group, a benzonaphthosilole group, a benzofurodibenzofuran group, a benzofurodibenzothiophene group, or a benzothienodibenzothiophene group).

The π electron-deficient nitrogen-containing C₁-C₆₀ cyclic group may be i) a group T4, ii) a fused ring group in which two or more group T4 are fused with each other, iii) a fused ring group in which one or more groups T4 and one or more groups T1 are fused with each other, iv) a fused ring group in which one or more groups T4 and one or more groups T3 are fused with each other, or v) a fused ring group in which one or more groups T4G, one or more groups T1, and one or more groups T3 are fused with each other (for example, a pyrazole group, an imidazole group, a triazole group, an oxazole group, an isoxazole group, an oxadiazole group, a thiazole group, an isothiazole group, a thiadiazole group, a benzopyrazole group, a benzimidazole group, a benzoxazole group, a benzoisoxazole group, a benzothiazole group, a benzoisothiazole group, a pyridine group, a pyrimidine group, a pyrazine group, a pyridazine group, a triazine group, a quinoline group, an isoquinoline group, a benzoquinoline group, a benzoisoquinoline group, a quinoxaline group, a benzoquinoxaline group, a quinazoline group, a benzoquinazoline group, a phenanthroline group, a cinnoline group, a phthalazine group, a naphthyridine group, an imidazopyridine group, an imidazopyrimidine group, an imidazotriazine group, an imidazopyrazine group, an imidazopyridazine group, an azacarbazole group, an azafluorene group, an azadibenzosilole group, an azadibenzothiophene group, or an azadibenzofuran group).

The group T1 may be a cyclopropane group, a cyclobutane group, a cyclopentane group, a cyclohexane group, a cycloheptane group, a cyclooctane group, a cyclobutene group, a cyclopentene group, a cyclopentadiene group, a cyclohexene group, a cyclohexadiene group, a cycloheptene group, an adamantane group, a norbornane (or a bicyclo[2.2.1]heptane) group, a norbornene group, a bicyclo[1.1.1]pentane group, a bicyclo[2.1.1]hexane group, a bicyclo[2.2.2]octane group, or a benzene group.

The group T2 may be a furan group, a thiophene group, a 1H-pyrrole group, a silole group, a borole group, a 2H-pyrrole group, a 3H-pyrrole group, an imidazole group, a pyrazole group, a triazole group, a tetrazole group, an oxazole group, an isoxazole group, an oxadiazole group, a thiazole group, an isothiazole group, a thiadiazole group, an azasilole group, an azaborole group, a pyridine group, a pyrimidine group, a pyrazine group, a pyridazine group, a triazine group, a tetrazine group, a pyrrolidine group, an imidazolidine group, a dihydropyrrole group, a piperidine group, a tetrahydropyridine group, a dihydropyridine group, a hexahydropyrimidine group, a tetrahydropyrimidine group, a dihydropyrimidine group, a piperazine group, a tetrahydropyrazine group, a dihydropyrazine group, a tetrahydropyridazine group, or a dihydropyridazine group.

The group T3 may be a furan group, a thiophene group, a 1H-pyrrole group, a silole group, or a borole group.

The group T4 may be a 2H-pyrrole group, a 3H-pyrrole group, an imidazole group, a pyrazole group, a triazole group, a tetrazole group, an oxazole group, an isoxazole group, an oxadiazole group, a thiazole group, an isothiazole group, a thiadiazole group, an azasilole group, an azaborole group, a pyridine group, a pyrimidine group, a pyrazine group, a pyridazine group, a triazine group, or a tetrazine group.

As used herein, the term “cyclic group,” “C₃-C₆₀ carbocyclic group,” “C₁-C₆₀ heterocyclic group,” “π electron-rich C₃-C₆₀ cyclic group,” or “IT electron-deficient nitrogen-containing C₁-C₆₀ cyclic group” may be a group condensed to an arbitrary cyclic group, a monovalent group, or a multivalent group (for example, a divalent group, a trivalent group, or a tetravalent group) according to a structure of a formula in which the term is used. For example, a “benzene group” may be a benzo group, a phenyl group, a phenylene group, or the like, which may be understood by those skilled in the art according to a structure of a formula including the “benzene group.”

For example, examples of a monovalent C₅-C₆₀ carbocyclic group and a monovalent C₁-C₆₀ heterocyclic group may include a C₃-C₁₀ cycloalkyl group, a C₁-C₁₀ heterocycloalkyl group, a C₃-C₁₀ cycloalkenyl group, a C₁-C₁₀ heterocycloalkenyl group, a C₆-C₆₀ aryl group, a C₁-C₆₀ heteroaryl group, a monovalent non-aromatic condensed polycyclic group, and a monovalent non-aromatic condensed hetero-polycyclic group, and examples of a divalent C₃-C₆₀ carbocyclic group and a divalent C₁-C₆₀ heterocyclic group may include a C₃-C₁₀ cycloalkylene group, a C₁-C₁₀ heterocycloalkylene group, a C₃-C₁₀ cycloalkenylene group, a C₁-C₁₀ heterocycloalkenylene group, a C₆-C₆₀ arylene group, a C₁-C₆₀ heteroarylene group, a divalent non-aromatic condensed polycyclic group, and a divalent non-aromatic condensed hetero-polycyclic group.

As used herein, the term “C₁-C₆₀ alkyl group” refers to a linear or branched aliphatic hydrocarbon monovalent group having 1 to 60 carbon atoms, and examples thereof include a methyl group, an ethyl group, an n-propyl group, an isopropyl group, an n-butyl group, a sec-butyl group, an isobutyl group, a tert-butyl group, an n-pentyl group, a tert-pentyl group, a neopentyl group, an isopentyl group, a sec-pentyl group, a 3-pentyl group, a sec-isopentyl group, an n-hexyl group, an isohexyl group, a sec-hexyl group, a tert-hexyl group, an n-heptyl group, an isoheptyl group, a sec-heptyl group, a tert-heptyl group, an n-octyl group, an isooctyl group, a sec-octyl group, a tert-octyl group, an n-nonyl group, an isononyl group, a sec-nonyl group, a tert-nonyl group, an n-decyl group, an isodecyl group, a sec-decyl group, a tert-decyl group, and the like. As used herein, the term “C₁-C₆₀ alkylene group” refers to a divalent group having substantially the same structure as the C₁-C₆₀ alkyl group.

As used herein, the term “C₂-C₆₀ alkenyl group” refers to a monovalent hydrocarbon group including one or more carbon-carbon double bonds at a main chain (e.g., in the middle) and/or a terminal end (e.g., a terminus) of a C₂-C₆₀ alkyl group, and examples thereof include an ethenyl group, a propenyl group, a butenyl group, and the like. As used herein, the term “C₂-C₆₀ alkenylene group” refers to a divalent group having substantially the same structure as the C₂-C₆₀ alkenyl group.

As used herein, the term “C₂-C₆₀ alkynyl group” refers to a monovalent hydrocarbon group including one or more carbon-carbon triple bonds at a main chain (e.g., in the middle) and/or a terminal end (e.g., a terminus) of a C₂-C₆₀ alkyl group, and examples thereof include an ethynyl group, a propynyl group, and the like. As used herein, the term “C₂-C₆₀ alkynylene group” refers to a divalent group having substantially the same structure as the C₂-C₆₀ alkynyl group.

As used herein, the term “C₁-C₆₀ alkoxy group” refers to a monovalent group having a formula of -OA₁₀₁, wherein A₁₀₁ is the C₁-C₆₀ alkyl group, and examples thereof include a methoxy group, an ethoxy group, an isopropyloxy group, and the like.

As used herein, the term “C₃-C₁₀ cycloalkyl group” refers to a monovalent saturated hydrocarbon cyclic group having 3 to 10 carbon atoms, and specific examples thereof include a cyclopropyl group, a cyclobutyl group, a cyclopentyl group, a cyclohexyl group, a cycloheptyl group, a cyclooctyl group, adamantanyl, a norbornanyl group (or, a bicyclo[2.2.1]heptyl group), a bicyclo[1.1.1]pentyl group, a bicyclo[2.1.1]hexyl group, a bicyclo[2.2.2]octyl group, and the like. As used herein, the term “C₃-C₁₀ cycloalkylene group” refers to a divalent group having substantially the same structure as the C₃-C₁₀ cycloalkyl group.

As used herein, the term “C₁-C₁₀ heterocycloalkyl group” refers to a monovalent cyclic group having 1 to 10 carbon atoms and further including at least one heteroatom as a ring-forming atom in addition to carbon atoms, and examples thereof include a 1,2,3,4-oxatriazolidinyl group, a tetrahydrofuranyl group, a tetrahydrothiophenyl group, and the like. As used herein, the term “C₁-C₁₀ heterocycloalkylene group” refers to a divalent group having substantially the same structure as the C₁-C₁₀ heterocycloalkyl group.

As used herein, the term “C₃-C₁₀ cycloalkenyl group” is a monovalent cyclic group which has 3 to 10 carbon atoms and refers to a group having at least one carbon-carbon double bond in a ring thereof but not having aromaticity (e.g., is not aromatic), and examples thereof include a cyclopentenyl group, a cyclohexenyl group, a cycloheptenyl group, and the like. As used herein, the term “C₃-C₁₀ cycloalkenylene group” refers to a divalent group having substantially the same structure as the C₃-C₁₀ cycloalkenyl group.

As used herein, the term “C₁-C₁₀ heterocycloalkenyl group” is a monovalent cyclic group which has 1 to 10 carbon atoms, further includes at least one heteroatom as a ring-forming atom in addition to carbon atoms, and has at least one double bond in a ring thereof. Examples of the C₁-C₁₀ heterocycloalkenyl group include a 4,5-dihydro-1,2,3,4-oxatriazolyl group, a 2,3-dihydrofuranyl group, a 2,3-dihydrothiophenyl group, and the like. As used herein, the term “C₁-C₁₀ heterocycloalkenylene group” refers to a divalent group having substantially the same structure as the C₁-C₁₀ heterocycloalkenyl group.

As used herein, the term “C₆-C₆₀ aryl group” refers to a monovalent group having a carbocyclic aromatic system which has 6 to 60 carbon atoms, and the term “C₆-C₆₀ arylene group” refers to a divalent group having a carbocyclic aromatic system which has 6 to 60 carbon atoms. Examples of the C₆-C₆₀ aryl group include a phenyl group, a pentalenyl group, a naphthyl group, an azulenyl group, an indacenyl group, an acenaphthyl group, a phenalenyl group, a phenanthrenyl group, an anthracenyl group, a fluoranthenyl group, a triphenylenyl group, a pyrenyl group, a chrysenyl group, a perylenyl group, a pentaphenyl group, a heptalenyl group, a naphthacenyl group, a picenyl group, a hexacenyl group, a pentacenyl group, a rubicenyl group, a coronenyl group, an ovalenyl group, and the like. When the C₆-C₆₀ aryl group and the C₆-C₆₀ arylene group include two or more rings, the two or more rings may be condensed with each other.

As used herein, the term “C₁-C₆₀ heteroaryl group” refers to a monovalent group further including at least one heteroatom as a ring-forming atom in addition to carbon atom and having a heterocyclic aromatic system which has 1 to 60 carbon atoms, and the C₁-C₆₀ heteroarylene group refers to a divalent group further including at least one heteroatom as a ring-forming atom in addition to carbon atoms and having a heterocyclic aromatic system which has 1 to 60 carbon atoms. Examples of the C₁-C₆₀ heteroaryl group include a pyridinyl group, a pyrimidinyl group, a pyrazinyl group, a pyridazinyl group, a triazinyl group, a quinolinyl group, a benzoquinolinyl group, an isoquinolinyl group, a benzoisoquinolinyl group, a quinoxalinyl group, a benzoquinoxalinyl group, a quinazolinyl group, a benzoquinazolinyl group, a cinnolinyl group, a phenanthrolinyl group, a phthalazinyl group, a naphthyridinyl group, and the like. When the C₁-C₆₀ heteroaryl group and the C₁-C₆₀ heteroarylene group include two or more rings, the two or more rings may be condensed with each other.

As used herein, the term “monovalent non-aromatic condensed polycyclic group” refers to a monovalent group (for example, having 8 to 60 carbon atoms) in which two or more rings are condensed with each other, which includes only carbon as a ring-forming atom, and of which the entire molecule has non-aromaticity. Examples of the monovalent non-aromatic condensed polycyclic group include an indenyl group, a fluorenyl group, a spiro-bifluorenyl group, a benzofluorenyl group, an indenophenanthrenyl group, an indenoanthracenyl group, and the like. As used herein, the term “divalent non-aromatic condensed polycyclic group” refers to a divalent group having substantially the same structure as the monovalent non-aromatic condensed polycyclic group.

As used herein, the term “monovalent non-aromatic condensed hetero-polycyclic group” refers to a monovalent group (for example, having 1 to 60 carbon atoms) in which two or more rings are condensed with each other, which further includes at least one heteroatom as a ring-forming atom in addition to carbon atoms, and of which the entire molecule has non-aromaticity (e.g., is not aromatic when considered as a whole). Examples of the monovalent non-aromatic condensed hetero-polycyclic group include a pyrrolyl group, a thiophenyl group, a furanyl group, an indolyl group, a benzoindolyl group, a naphthoindolyl group, an isoindolyl group, a benzoisoindolyl group, a naphthoisoindolyl group, a benzosilolyl group, a benzothiophenyl group, a benzofuranyl group, a carbazolyl group, a dibenzosilolyl group, a dibenzothiophenyl group, a dibenzofuranyl group, an azacarbazolyl group, an azafluorenyl group, an azadibenzosilolyl group, an azadibenzothiophenyl group, an azadibenzofuranyl group, a pyrazolyl group, an imidazolyl group, a triazolyl group, a tetrazolyl group, an oxazolyl group, an isoxazolyl group, a thiazolyl group, an isothiazolyl group, an oxadiazolyl group, a thiadiazolyl group, a benzopyrazolyl group, a benzimidazolyl group, a benzoxazolyl group, a benzothiazolyl group, a benzoxadiazolyl group, a benzothiadiazolyl group, an imidazopyridinyl group, an imidazopyrimidinyl group, an imidazotriazinyl group, an imidazopyrazinyl group, an imidazopyridazinyl group, an indenocarbazolyl group, an indolocarbazolyl group, a benzofurocarbazolyl group, a benzothienocarbazolyl group, a benzosilolocarbazolyl group, a benzoindolocarbazolyl group, a benzocarbazolyl group, a benzonaphthofuranyl group, a benzonaphthothiophenyl group, a benzonaphthosilolyl group, a benzofurodibenzofuranyl group, a benzofurodibenzothiophenyl group, a benzothienodibenzothiophenyl group, and the like. As used herein, the term “divalent non-aromatic condensed hetero-polycyclic group” refers to a divalent group having substantially the same structure as the monovalent non-aromatic condensed hetero-polycyclic group.

As used herein, the term “C₆-C₆₀ aryloxy group” refers to -OA₁₀₂, wherein A₁₀₂ is the C₆-C₆₀ aryl group, and the C₆-C₆₀ arylthio group refers to -SA₁₀₃, wherein A₁₀₃ is the C₆-C₆₀ aryl group.

As used herein, the term “C₇-C₆₀ arylalkyl group” refers to -A₁₀₄A₁₀₅, wherein A₁₀₄ is a C₁-C₅₄ alkylene group and A₁₀₅ is a C₆-C₅₉ aryl group, and as used herein, the term “C₂-C₆₀ heteroarylalkyl group” refers to -A₁₀₆A₁₀₇, wherein A₁₀₆ is a C₁-C₅₉ alkylene group and A₁₀₇ is a C₁-C₅₉ heteroaryl group.

As used herein, “R₁₀ₐ” may be: deuterium, —F, —Cl, —Br, —I, a hydroxyl group, a cyano group, or a nitro group; a C₁-C₆₀ alkyl group, a C₂-C₆₀ alkenyl group, a C₂-C₆₀ alkynyl group, or a C₁-C₆₀ alkoxy group, each unsubstituted or substituted with deuterium, —F, —Cl, —Br, —I, a hydroxyl group, a cyano group, a nitro group, a C₃-C₆₀ carbocyclic group, a C₁-C₆₀ heterocyclic group, a C₆-C₆₀ aryloxy group, a C₆-C₆₀ arylthio group, a C₇-C₆₀ arylalkyl group, a C₂-C₆₀ heteroarylalkyl group, —Si(Q₁₁)(Q₁₂)(Q₁₃), —N(Q₁₁)(Q₁₂), —B(Q₁₁)(Q₁₂), —C(═O)(Q₁₁), —S(═O)₂(Q₁₁), —P(═O)(Q₁₁)(Q₁₂), or any combination thereof; a C₃-C₆₀ carbocyclic group, a C₁-C₆₀ heterocyclic group, a C₆-C₆₀ aryloxy group, a C₆-C₆₀ arylthio group, a C₇-C₆₀ arylalkyl group, or a C₂-C₆₀ heteroarylalkyl group, each unsubstituted or substituted with deuterium, —F, —Cl, —Br, —I, a hydroxyl group, a cyano group, a nitro group, a C₁-C₆₀ alkyl group, a C₂-C₆₀ alkenyl group, a C₂-C₆₀ alkynyl group, a C₁-C₆₀ alkoxy group, a C₃-C₆₀ carbocyclic group, a C₁-C₆₀ heterocyclic group, a C₆-C₆₀ aryloxy group, a C₆-C₆₀ arylthio group, a C₇-C₆₀ arylalkyl group, a C₂-C₆₀ heteroarylalkyl group, Si(Q₂₁)(Q₂₂)(Q₂₃), —N(Q₂₁)(Q₂₂), —B(Q₂₁)(Q₂₂), —C(═O)(Q₂₁), —S(═O)₂(Q₂₁), —P(═O)(Q₂₁)(Q₂₂), or any combination thereof; or —Si(Q₃₁)(Q₃₂)(Q₃₃), —N(Q₃₁)(Q₃₂), —B(Q₃₁)(Q₃₂), —C(═O)(Q₃₁), —S(═O)₂(Q₃₁), or —P(═O)(Q₃₁)(Q₃₂).

As used herein, Q₁ to Q₃, Q₁₁ to Q₁₃, Q₂₁ to Q₂₃, and Q₃₁ to Q₃₃ may each independently be: hydrogen; deuterium; —F; —Cl; —Br; —I; a hydroxyl group; a cyano group; a nitro group; a C₁-C₆₀ alkyl group; a C₂-C₆₀ alkenyl group; a C₂-C₆₀ alkynyl group; a C₁-C₆₀ alkoxy group; or a C₃-C₆₀ carbocyclic group, a C₁-C₆₀ heterocyclic group, a C₇-C₆₀ arylalkyl group, or a C₂-C₆₀ heteroarylalkyl group, each unsubstituted or substituted with deuterium, —F, a cyano group, a C₁-C₆₀ alkyl group, a C₁-C₆₀ alkoxy group, a phenyl group, a biphenyl group, or any combination thereof.

As used herein, the term “heteroatom” refers to any atom other than a carbon atom. Examples of the heteroatom include O, S, N, P, Si, B, Ge, Se, or any combination thereof.

As used herein, the term “third-row transition metal” includes hafnium (Hf), tantalum (Ta), tungsten (W), rhenium (Re), osmium (Os), iridium (Ir), platinum (Pt), gold (Au), or the like.

As used herein, the term “Ph” refers to a phenyl group, the term “Me” refers to a methyl group, the term “Et” refers to an ethyl group, the term “tert-Bu” or “But” refers to a tert-butyl group, and the term “OMe” refers to a methoxy group.

As used herein, the term “biphenyl group” refers to a “phenyl group substituted with a phenyl group.” The “biphenyl group” belongs to a “substituted phenyl group” of which a substituent is a “C₆-C₆₀ aryl group.”

As used herein, the term “terphenyl group” refers to a “phenyl group substituted with a biphenyl group.” The “terphenyl group” belongs to a “substituted phenyl group” of which a substituent is a “C₆-C₆₀ aryl group substituted with a C₆-C₆₀ aryl group.”

In the definition of a substituent, the number of carbon atoms merely an example. For example, in a C₁-C₆₀ alkyl group, Coo is merely an example, and the definition of an alkyl group is equally applied to a C₁-C₂₀ alkyl group. The same is applied to other substituents.

Any hydrogen in a compound structure of the present specification may be optionally substituted with deuterium.

Spatially relative terms, such as “below,” “beneath,” “lower,” “above,” “upper,” and the like, may be used herein to easily describe a relationship between one device or components and other devices or components. Spatially relative terms are to be understood to include different orientations of a device when in use or operation. For example, devices described as “below” or “beneath” other devices may be provided “above” the other devices. Thus, the example term “below” may encompass both orientations of above and below. A device may be otherwise oriented, and thus spatially relative terms may be interpreted according to orientation.

Hereinafter, a composition according to an embodiment will be described in more detail with reference to Examples.

### EXAMPLES

### Examination of Solubility

Whether each initiator component had solubility with respect to a solvent was examined. Results thereof are shown in Table 1 below.

The examination was conducted by confirming an appearance in a concentration ratio of each of initiation systems (three types)/monomer=2.5 mg/2.5 mL.

TABLE 1

| | Initiation System | | | |
|---|---|---|---|---|
| | | Compound | Compound | Tg (° C.) of |
| Monomer | 4DP-IPN | 2-4 | 3-2 | homopolymer |
| 2-hydroxyethyl | x | x | x | −10 |
| acrylate (HEA) | | | | |
| IBOA | ∘ | ∘ | x | 97 |
| EHA | ∘ | ∘ | x | −40 |
| Compound 4-2 | ∘ | ∘ | ∘ | 119 |
| (DMAA) | | | | |
| Compound 4-1 | ∘ | ∘ | ∘ | 81 |
| (DEAA) | | | | |
| Compound 4-3 | ∘ | ∘ | ∘ | 145 |
| (ACMO) | | | | |
| 1-vinyl-2- | ∘ | ∘ | ∘ | 180 |
| pyrrolidinone | | | | |
| (NYP) | | | | |

For an efficient catalytic cycle, a compound of Formula 1 (for example, 4DP-IPN), a compound of Formula 2 (for example, compound 2-4), and a compound of Formula 3 (for example, compound 3-2), which are essential components, all have to be uniformly dissolved.

As shown in Table 1, components of three types of initiation systems have to be dissolved, and in order to allow an elastic modulus of a cured product to be 200 MPa or more, a Tg of a homopolymer needs to be 80° C. or more.

A monomer capable of satisfying both conditions of uniform dissolution and Tg of the homopolymer of 80° C. or more was selected.

NVP satisfied both conditions, but NVP was excluded because NVP it lacked copolymerizability and significantly reduced an elastic modulus of a cured product.

Composition Preparation

### Comparative Example 1

A composition was prepared by mixing 5 wt % (50,000 ppm) of Irgacure 819, 40 wt % of epoxy acrylate (BIS A GMA) as an oligomer, 25 wt % of HEA, and IBOA as the remainder.

Irgacure 819 is a commercially available initiator.

### Comparative Example 2

A composition was prepared in the same manner as in Comparative Example 1, except that 50 ppm of 4DP-IPN, 600 ppm of compound 2-4, and 700 ppm of compound 3-2 were used as a visible light initiator mixture (total of 1,350 ppm) instead of Irgacure 819 as an initiator, and IBOA as the remainder was used.

### Example 1

A composition was prepared in substantially the same manner as in Comparative Example 1, except that 50 ppm of 4DP-IPN, 600 ppm of compound 2-4, and 700 ppm of compound 3-2 were used as a visible light initiator mixture instead of Irgacure 819 as an initiator, and compound 4-2 was used instead of IBOA in a monomer.

### Example 2

A composition was prepared in substantially the same manner as in Example 1, except that compound 4-1 was used instead of compound 4-2 in a monomer.

### Example 3

A composition was prepared in substantially the same manner as in Example 1, except that compound 4-3 was used instead of compound 4-2 in a monomer.

### Example 4

A composition was prepared in substantially the same manner as in Example 1, except that compounds 4-1, 4-2, and 4-3 were used in a weight ratio of 1:1:1 instead of compound 4-2 in a monomer.

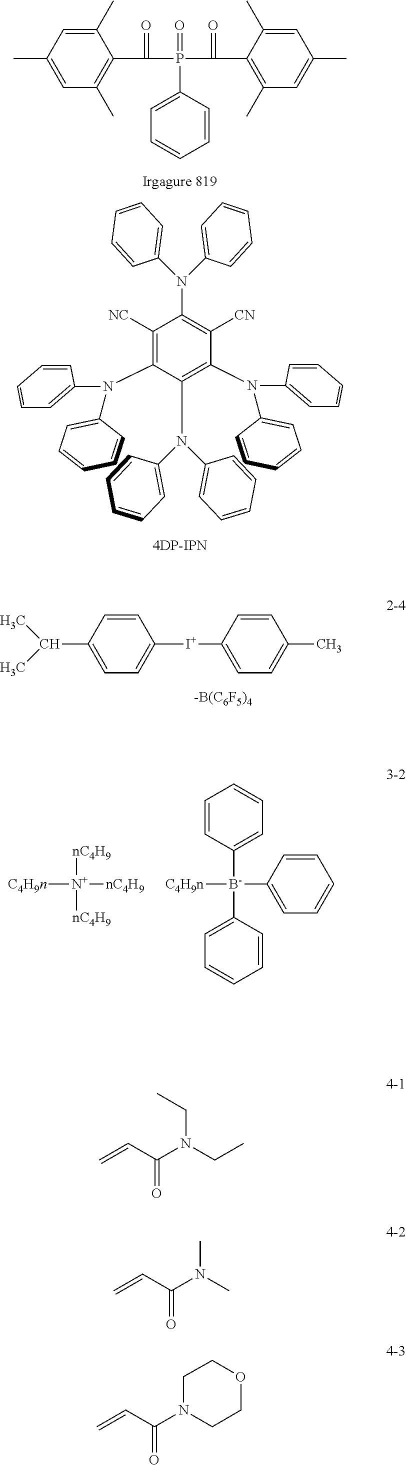

### Measurement of Values of Physical Properties

Tg values and moduli of cured products of the compositions of Comparative Example 1, and Comparative Example 2, and Examples 1, 2 and 3 are shown in Table 2 below.

TABLE 2

| | | | Tg (° C.) | |
|---|---|---|---|---|
| | Included | | of cured | Modulus E′ |
| | monomer | Initiator | product | (MPa)@25° C. |
| Comparative | HEA/IBOA | Irgacure 819 | 50 | 640 |
| Example 1 | | | | |
| Comparative | HEA/IBOA | 4DP-IPN, 2-4, | 35 | 140 |
| Example 2 | | 3-3 | | |
| Example 1 | HEA/4-2 | 4DP-IPN, 2-4, | 64 | 824 |
| | | 3-3 | | |
| Example 2 | HEA/4-1 | 4DP-IPN, 2-4, | 60 | 756 |
| | | 3-3 | | |
| Example 3 | HEA/4-3 | 4DP-IPN, 2-4, | 82 | 922 |
| | | 3-3 | | |

### Polyimide (PI) Through Curing

The compositions prepared in Example 1 and Comparative Example 1 were applied onto a substrate to a thickness of 30 μm, and then each of light with 450 nm (100 MW/cm²) and light with 480 nm (120 MW/cm²) was allowed to pass through a polyimide film (25 μm) and a silicone film (3 mm) and irradiated for 10 seconds, 30 seconds, and 60 seconds. A degree of conversion of each formed polymer was measured using Fourier transform infrared spectroscopy (FT-IR) and shown in Table 3 below.

When light passes through the polyimide film (25 μm) and the silicone film (3 mm), it was confirmed that 14.5% of light was transmitted at 450 nm, and 22.4% of light was transmitted at 480 nm.

TABLE 3

| | 450 nm (100 MW/cm²) | | 480 nm (120 MW/cm²) | |
|---|---|---|---|---|
| | Comparative | | Comparative | |
| | Example 1 | Example 1 | Example 1 | Example 1 |
| 10 | 90.93 | 97.53 | 42.47 | 98.88 |
| seconds | | | | |
| 30 | 98.39 | 99.76 | 90.25 | 99.18 |
| seconds | | | | |
| 60 | 98.98 | 98.62 | 95.46 | 99.07 |
| seconds | | | | |

Referring to Table 3, it may be seen that the degree of conversion of Example 1 is higher than that of Comparative Example 1.

With respect to Comparative Example 1, it may be seen that the degree of conversion decreases as a wavelength becomes longer. This means that the performance of general initiators is insufficient in the case of long wavelengths.

A polymer formed by curing a composition according to an embodiment with visible light may have excellent physical properties.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described, it will be understood by those of ordinary skill in the art that various suitable changes in form and details may be made therein without departing from the spirit and scope of the present disclosure as defined by the following claims, and equivalents thereof.

What is claimed is:

1. A composition comprising:
a visible light initiator mixture; and
a monomer,
wherein the visible light initiator mixture comprises an ionic compound and a multi-aromatic ring-containing compound, and
the monomer is a monomer in which a glass transition temperature (Tg) of a homopolymer of the monomer is 80° C. or more.

2. The composition of claim 1, wherein the visible light initiator mixture generates radicals upon exposure to light having a wavelength of about 400 nm to about 560 nm.

3. The composition of claim 1, wherein the multi-aromatic ring-containing compound comprises a first compound represented by Formula 1 below: 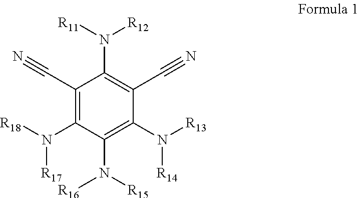
wherein R₁₁ to R₁₈ are each independently hydrogen, deuterium, —F, —Cl, —Br, —I, a hydroxyl group, a cyano group, a nitro group, a C₁-C₆₀ alkyl group unsubstituted or substituted with at least one R₁₀ₐ, a C₂-C₆₀ alkenyl group unsubstituted or substituted with at least one R₁₀ₐ, a C₂-C₆₀ alkynyl group unsubstituted or substituted with at least one R₁₀ₐ, a C₁-C₆₀ alkoxy group unsubstituted or substituted with at least one R₁₀ₐ, a C₃-C₆₀ carbocyclic group unsubstituted or substituted with at least one R₁₀ₐ, a C₁-C₆₀ heterocyclic group unsubstituted or substituted with at least one R₁₀ₐ, a C₆-C₆₀ aryloxy group unsubstituted or substituted with at least one R₁₀ₐ, a C₆-C₆₀ arylthio group unsubstituted or substituted with at least one R₁₀ₐ, —Si(Q₁)(Q₂)(Q₃), —N(Q₁)(Q₂), —B(Q₁)(Q₂), —C(═O)(Q₁), —S(═O)₂(Q₁), or —P(═O)(Q₁)(Q₂),
two or more adjacent ones of R₁₁ to R₁₈ are optionally linked to each other to form a C₅-C₃₀ carbocyclic group unsubstituted or substituted with at least one R₁₀ₐ or a C₁-C₃₀ heterocyclic group unsubstituted or substituted with at least one R₁₀ₐ,
R₁₀ₐ is: deuterium, —F, —Cl, —Br, —I, a hydroxyl group, a cyano group, or a nitro group;
a C₁-C₆₀ alkyl group, a C₂-C₆₀ alkenyl group, a C₂-C₆₀ alkynyl group, or a C₁-C₆₀ alkoxy group, each unsubstituted or substituted with deuterium, —F, —Cl, —Br, —I, a hydroxyl group, a cyano group, a nitro group, a C₅-C₆₀ carbocyclic group, a C₁-C₆₀ heterocyclic group, a C₆-C₆₀ aryloxy group, a C₆-C₆₀ arylthio group, a C₇-C₆₀ arylalkyl group, a C₂-C₆₀ heteroarylalkyl group, —Si(Q₁₁)(Q₁₂)(Q₁₃), —N(Q₁₁)(Q₁₂), —B(Q₁₁)(Q₁₂), —C(═O)(Q₁₁), —S(═O)₂(Q₁₁), —P(═O)(Q₁₁)(Q₁₂), or any combination thereof; a C₃-C₆₀ carbocyclic group, a C₁-C₆₀ heterocyclic group, a C₆-C₆₀ aryloxy group, a C₆-C₆₀ arylthio group, a C₇-C₆₀ arylalkyl group, or a C₂-C₆₀ heteroarylalkyl group, each unsubstituted or substituted with deuterium, —F, —Cl, —Br, —I, a hydroxyl group, a cyano group, a nitro group, a C₁-C₆₀ alkyl group, a C₂-C₆₀ alkenyl group, a C₂-C₆₀ alkynyl group, a C₁-C₆₀ alkoxy group, a C₃-C₆₀ carbocyclic group, a C₁-C₆₀ heterocyclic group, a C₆-C₆₀ aryloxy group, a C₆-C₆₀ arylthio group, a C₇-C₆₀ arylalkyl group, a C₂-C₆₀ heteroarylalkyl group, Si(Q₂₁)(Q₂₂)(Q₂₃), —N(Q₂₁)(Q₂₂), —B(Q₂₁)(Q₂₂), —C(═O)(Q₂₁), —S(═O)₂(Q₂₁), —P(═O)(Q₂₁)(Q₂₂), or any combination thereof; or —Si(Q₃₁)(Q₃₂)(Q₃₃), —N(Q₃₁)(Q₃₂), —B(Q₃₁)(Q₃₂), —C(═O)(Q₃₁), —S(═O)₂(Q₃₁), or —P(═O)(Q₃₁)(Q₃₂), and Q₁ to Q₃, Q₁₁ to Q₁₃, Q₂₁ to Q₂₃, and Q₃₁ to Q₃₃ are each independently: hydrogen; deuterium; —F; —Cl; —Br; —I; a hydroxyl group; a cyano group; a nitro group; a C₁-C₆₀ alkyl group; a C₂-C₆₀ alkenyl group; a C₂-C₆₀ alkynyl group; a C₁-C₆₀ alkoxy group; or a C₃-C₆₀ carbocyclic group, a C₁-C₆₀ heterocyclic group, a C₇-C₆₀ arylalkyl group, or a C₂-C₆₀ heteroarylalkyl group, each unsubstituted or substituted with deuterium, —F, a cyano group, a C₁-C₆₀ alkyl group, a C₁-C₆₀ alkoxy group, a phenyl group, a biphenyl group, or any combination thereof.

4. The composition of claim 3, wherein the first compound is represented by Formula 1-1 or Formula 1-2 below: 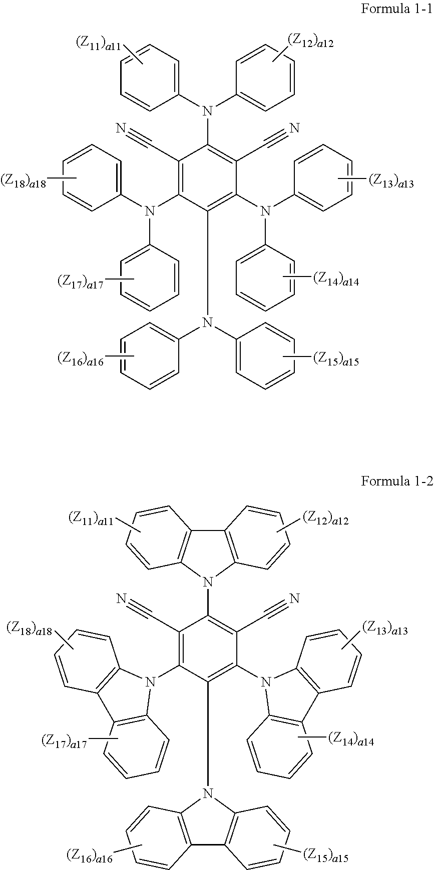
wherein, in Formulae 1-1 and 1-2, Z₁₁ to Z₁₈ are each independently hydrogen or defined as for R₁₀ₐ in claim 3, and
a11 to a18 are each independently an integer from 1 to 4 or 1 to 5.

5. The composition of claim 3, wherein the first compound comprises at least one selected from among compounds below:

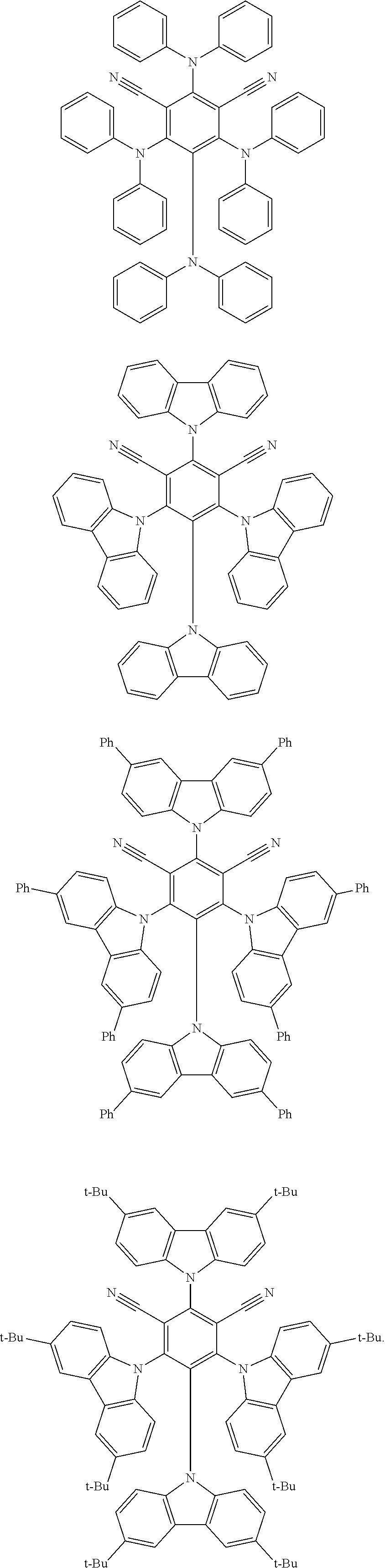

6. The composition of claim 1, wherein the ionic compound comprises a second compound represented by Formula 2 below, a third compound represented by Formula 3 below, or any combination thereof: 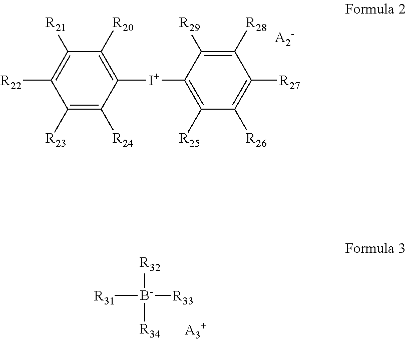
wherein, in Formulae 2 and 3,
A₂_{^{−}} is a counter anion,
A₃_{⁺} is a counter cation,
R₂₀ to R₂₉ and R₃₁ to R₃₄ are each independently hydrogen, deuterium, —F, —Cl, —Br, —I, a hydroxyl group, a cyano group, a nitro group, a C₁-C₆₀ alkyl group unsubstituted or substituted with at least one R₁₀ₐ, a C₂-C₆₀ alkenyl group unsubstituted or substituted with at least one R₁₀ₐ, a C₂-C₆₀ alkynyl group unsubstituted or substituted with at least one R₁₀ₐ, a C₁-C₆₀ alkoxy group unsubstituted or substituted with at least one R₁₀ₐ, a C₃-C₆₀ carbocyclic group unsubstituted or substituted with at least one R₁₀ₐ, a C₁-C₆₀ heterocyclic group unsubstituted or substituted with at least one R₁₀ₐ, a C₆-C₆₀ aryloxy group unsubstituted or substituted with at least one R₁₀ₐ, a C₆-C₆₀ arylthio group unsubstituted or substituted with at least one R₁₀ₐ, —Si(Q₁)(Q₂)(Q₃), —N(Q₁)(Q₂), —B(Q₁)(Q₂), —C(═O)(Q₁), —S(═O)₂(Q₁), or —P(═O)(Q₁)(Q₂),
two or more adjacent ones of R₂₀ to R₂₉ are optionally linked to each other to form a C₅-C₃₀ carbocyclic group unsubstituted or substituted with at least one R₁₀ₐ or a C₁-C₃₀ heterocyclic group unsubstituted or substituted with at least one R₁₀ₐ,
two or more adjacent ones of R₃₁ to R₃₄ are optionally linked to each other to form a C₅-C₃₀ carbocyclic group unsubstituted or substituted with at least one R₁₀ₐ or a C₁-C₃₀ heterocyclic group unsubstituted or substituted with at least one R₁₀ₐ,
R₁₀ₐ is: deuterium, —F, —Cl, —Br, —I, a hydroxyl group, a cyano group, or a nitro group;
a C₁-C₆₀ alkyl group, a C₂-C₆₀ alkenyl group, a C₂-C₆₀ alkynyl group, or a C₁-C₆₀ alkoxy group, each unsubstituted or substituted with deuterium, —F, —Cl, —Br, —I, a hydroxyl group, a cyano group, a nitro group, a C₃-C₆₀ carbocyclic group, a C₁-C₆₀ heterocyclic group, a C₆-C₆₀ aryloxy group, a C₆-C₆₀ arylthio group, a C₇-C₆₀ arylalkyl group, a C₂-C₆₀ heteroarylalkyl group, —Si(Q₁₁)(Q₁₂)(Q₁₃), —N(Q₁₁)(Q₁₂), —B(Q₁₁)(Q₁₂), —C(═O)(Q₁₁), —S(═O)₂(Q₁₁), —P(═O)(Q₁₁)(Q₁₂), or any combination thereof; a C₃-C₆₀ carbocyclic group, a C₁-C₆₀ heterocyclic group, a C₆-C₆₀ aryloxy group, a C₆-C₆₀ arylthio group, a C₇-C₆₀ arylalkyl group, or a C₂-C₆₀ heteroarylalkyl group, each unsubstituted or substituted with deuterium, —F, —Cl, —Br, —I, a hydroxyl group, a cyano group, a nitro group, a C₁-C₆₀ alkyl group, a C₂-C₆₀ alkenyl group, a C₂-C₆₀ alkynyl group, a C₁-C₆₀ alkoxy group, a C₃-C₆₀ carbocyclic group, a C₁-C₆₀ heterocyclic group, a C₆-C₆₀ aryloxy group, a C₆-C₆₀ arylthio group, a C₇-C₆₀ arylalkyl group, a C₂-C₆₀ heteroarylalkyl group, Si(Q₂₁)(Q₂₂)(Q₂₃), —N(Q₂₁)(Q₂₂), —B(Q₂₁)(Q₂₂), —C(═O)(Q₂₁), —S(═O)₂(Q₂₁), —P(═O)(Q₂₁)(Q₂₂), or any combination thereof; or —Si(Q₃₁)(Q₃₂)(Q₃₃), —N(Q₃₁)(Q₃₂), —B(Q₃₁)(Q₃₂), —C(═O)(Q₃₁), —S(═O)₂(Q₃₁), or —P(═O)(Q₃₁)(Q₃₂), and
Q₁ to Q₃, Q₁₁ to Q₁₃, Q₂₁ to Q₂₃, and Q₃₁ to Q₃₃ are each independently: hydrogen; deuterium; —F; —Cl; —Br; —I; a hydroxyl group; a cyano group; a nitro group; a C₁-C₆₀ alkyl group; a C₂-C₆₀ alkenyl group; a C₂-C₆₀ alkynyl group; a C₁-C₆₀ alkoxy group; or a C₅-C₆₀ carbocyclic group, a C₁-C₆₀ heterocyclic group, a C₇-C₆₀ arylalkyl group, or a C₂-C₆₀ heteroarylalkyl group, each unsubstituted or substituted with deuterium, —F, a cyano group, a C₁-C₆₀ alkyl group, a C₁-C₆₀ alkoxy group, a phenyl group, a biphenyl group, or any combination thereof.

7. The composition of claim 6, wherein A₂_{^{−}} comprises a fluorine atom.

8. The composition of claim 6, wherein A₃_{⁺} is [P(R₃₁ₐ)(R_{31b})(R_{31c})(R_{31d})]⁺ or [N(R₃₂ₐ)(R_{32b})(R_{32c})(R_{32d})]⁺,
R₃₁ₐ, R_{31b}, R_{31c}, R_{31d}, R₃₂ₐ, R_{32b}, R_{32c}, and R_{32d} are each independently a C₁-C₆₀ alkyl group unsubstituted or substituted with at least one R₁₀ₐ, a C₂-C₆₀ alkenyl group unsubstituted or substituted with at least one R₁₀ₐ, a C₂-C₆₀ alkynyl group unsubstituted or substituted with at least one R₁₀ₐ, a C₁-C₆₀ alkoxy group unsubstituted or substituted with at least one R₁₀ₐ, a C₃-C₆₀ carbocyclic group unsubstituted or substituted with at least one R₁₀ₐ, or a C₁-C₆₀ heterocyclic group unsubstituted or substituted with at least one R₁₀ₐ.

9. The composition of claim 6, wherein the second compound comprises at least one selected from among compounds below:

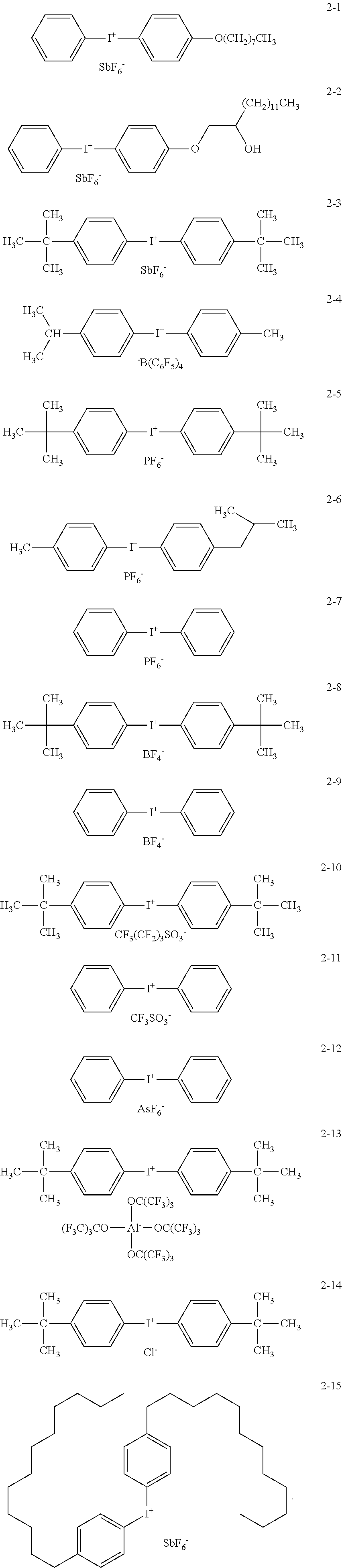

10. The composition of claim 6, wherein the third compound comprises at least one selected from among compounds below:

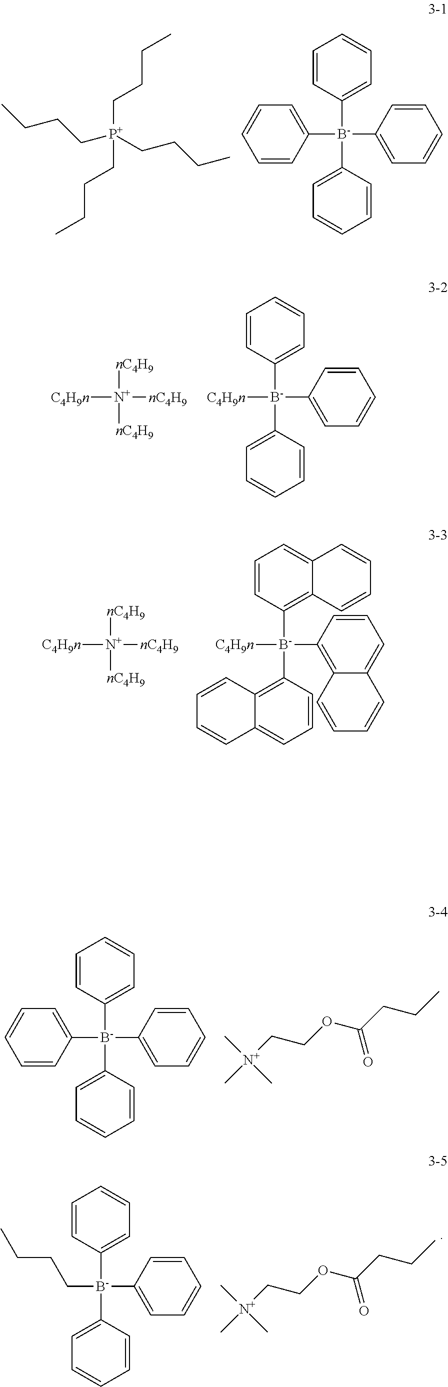

11. The composition of claim 1, wherein the monomer comprises a (meth)acrylamide-based monomer.

12. The composition of claim 1, wherein the monomer comprises a fourth compound represented by Formula 4 below: 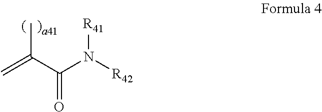
wherein, in Formula 4,
R₄₁ and R₄₂ are each independently a C₁-C₆₀ alkyl group unsubstituted or substituted with at least one R₁₀ₐ, a C₂-C₆₀ alkenyl group unsubstituted or substituted with at least one R₁₀ₐ, a C₂-C₆₀ alkynyl group unsubstituted or substituted with at least one R₁₀ₐ, a C₁-C₆₀ alkoxy group unsubstituted or substituted with at least one R₁₀ₐ, a C₃-C₆₀ carbocyclic group unsubstituted or substituted with at least one R₁₀ₐ, or a C₁-C₆₀ heterocyclic group unsubstituted or substituted with at least one R₁₀ₐ,
a41 is 0 or 1,
R₄₁ and R₄₂ are optionally linked to each other to form a C₅-C₃₀ carbocyclic group unsubstituted or substituted with at least one R₁₀ₐ or a C₁-C₃₀ heterocyclic group unsubstituted or substituted with at least one R₁₀ₐ,
R₁₀ₐ is: deuterium, —F, —Cl, —Br, —I, a hydroxyl group, a cyano group, or a nitro group;
a C₁-C₆₀ alkyl group, a C₂-C₆₀ alkenyl group, a C₂-C₆₀ alkynyl group, or a C₁-C₆₀ alkoxy group, each unsubstituted or substituted with deuterium, —F, —Cl, —Br, —I, a hydroxyl group, a cyano group, a nitro group, a C₅-C₆₀ carbocyclic group, a C₁-C₆₀ heterocyclic group, a C₆-C₆₀ aryloxy group, a C₆-C₆₀ arylthio group, a C₇-C₆₀ arylalkyl group, a C₂-C₆₀ heteroarylalkyl group, —Si(Q₁₁)(Q₁₂)(Q₁₃), —N(Q₁₁)(Q₁₂), —B(Q₁₁)(Q₁₂), —C(═O)(Q₁₁), —S(═O)₂(Q₁₁), —P(═O)(Q₁₁)(Q₁₂), or any combination thereof; a C₃-C₆₀ carbocyclic group, a C₁-C₆₀ heterocyclic group, a C₆-C₆₀ aryloxy group, a C₆-C₆₀ arylthio group, a C₇-C₆₀ arylalkyl group, or a C₂-C₆₀ heteroarylalkyl group, each unsubstituted or substituted with deuterium, —F, —Cl, —Br, —I, a hydroxyl group, a cyano group, a nitro group, a C₁-C₆₀ alkyl group, a C₂-C₆₀ alkenyl group, a C₂-C₆₀ alkynyl group, a C₁-C₆₀ alkoxy group, a C₃-C₆₀ carbocyclic group, a C₁-C₆₀ heterocyclic group, a C₆-C₆₀ aryloxy group, a C₆-C₆₀ arylthio group, a C₇-C₆₀ arylalkyl group, a C₂-C₆₀ heteroarylalkyl group, Si(Q₂₁)(Q₂₂)(Q₂₃), —N(Q₂₁)(Q₂₂), —B(Q₂₁)(Q₂₂), —C(═O)(Q₂₁), —S(═O)₂(Q₂₁), —P(═O)(Q₂₁)(Q₂₂), or any combination thereof; or —Si(Q₃₁)(Q₃₂)(Q₃₃), —N(Q₃₁)(Q₃₂), —B(Q₃₁)(Q₃₂), —C(═O)(Q₃₁), —S(═O)₂(Q₃₁), or —P(═O)(Q₃₁)(Q₃₂), and
Q₁ to Q₃, Q₁₁ to Q₁₃, Q₂₁ to Q₂₃, and Q₃₁ to Q₃₃ are each independently: hydrogen; deuterium; —F; —Cl; —Br; —I; a hydroxyl group; a cyano group; a nitro group; a C₁-C₆₀ alkyl group; a C₂-C₆₀ alkenyl group; a C₂-C₆₀ alkynyl group; a C₁-C₆₀ alkoxy group; or a C₃-C₆₀ carbocyclic group, a C₁-C₆₀ heterocyclic group, a C₇-C₆₀ arylalkyl group, or a C₂-C₆₀ heteroarylalkyl group, each unsubstituted or substituted with deuterium, —F, a cyano group, a C₁-C₆₀ alkyl group, a C₁-C₆₀ alkoxy group, a phenyl group, a biphenyl group, or any combination thereof.

13. The composition of claim 12, wherein the fourth compound comprises at least one selected from among compounds below:

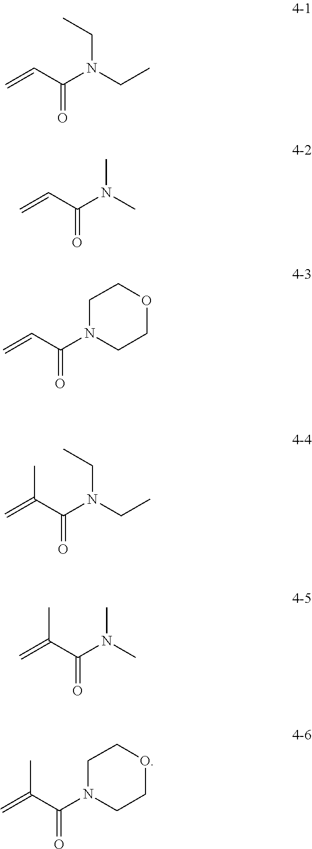

14. The composition of claim 1, wherein a concentration of the multi-aromatic ring-containing compound is greater than 0 ppm and less than or equal to 100 ppm.

15. The composition of claim 6, wherein a concentration of the second compound is in a range of about 500 ppm to about 2,000 ppm, and
a concentration of the third compound is in a range of about 600 ppm to about 2,000 ppm.

16. The composition of claim 1, wherein an amount of the monomer is in a range of about 1 wt % to about 50 wt %.

17. A polymer formed by irradiating visible light onto the composition of claim 1.

18. The polymer of claim 17, wherein a peak wavelength of the irradiating visible light is in a range of about 400 nm to about 560 nm.

19. The polymer of claim 17, wherein a modulus of the polymer is 200 MPa or more.
